(19) United States
(12) Patent Application Publication
(10) Pub. No.: US 2018/0347505 A1
(43) Pub. Date: Dec. 6, 2018

(54) METHOD FOR REMANUFACTURING AN ENGINE BLOCK

(71) Applicant: Caterpillar Inc., Peoria, IL (US)

(72) Inventors: Kegan Luick, Corinth, MS (US); Robert Eugene Sharp, Corinth, MS (US)

(73) Assignee: Caterpillar Inc., Peoria, IL (US)

(21) Appl. No.: 15/612,395

(22) Filed: Jun. 2, 2017

(51) Int. Cl. F02F 1/00; F02F 7/00

(52) U.S. Cl. CPC F02F 1/004; F02F 2200/00; F02F 7/0095

(57) ABSTRACT

A method for remanufacturing an engine block is provided. The engine block includes a damaged area on an inner surface of a cylinder. The method includes removing a first liner from the cylinder. The first liner includes a first inner diameter defined by a first inner surface and a first outer diameter defined by a first outer surface. The method includes removing material from the damaged area on the inner surface of the cylinder. The method also includes providing a machined surface on the inner surface of the cylinder. The machined surface defining a machined diameter. The method further includes inserting a second liner into the cylinder. The second liner includes a second inner diameter defined by a second inner surface and a second outer diameter defined by a second outer surface. The second outer diameter is equal to the machined diameter.

### TECHNICAL FIELD

The present disclosure relates to a method for remanufacturing an engine block. More particularly, the present disclosure relates to the method for remanufacturing the engine block using a liner.

### BACKGROUND

Generally, for an engine employing a cylinder liner within a cylinder of an engine block, a sealing element may be used at an interface of an outer surface of the cylinder liner and an inner surface of the cylinder in order to seal a joint therebetween. During a lifecycle of the engine, the inner surface of the cylinder around the sealing element may experience damage in the form of wear, corrosion, erosion, cavitation, and so on. As a result, the damaged inner surface of the engine block may require salvage repair for future use of the engine block as a remanufactured product.

Currently, a remanufacturing process for repairing the damaged area includes machining the damaged area in order to form an oversized counterbore to machine away the damage in the inner surface of the cylinder. Further, a repair ring is used in the machined area in order to restore the counterbore back to a pre-machined dimension of the cylinder. Additionally, a new cylinder liner and/or one or more sealing elements may be used in the cylinder in association with the repair ring.

However, this remanufacturing process of using the repair ring results in a number of quality issues in the remanufactured engine block and during operation of the engine, such as use of an additional component such as the repair ring with exact dimensions as that of the machined area, dimensional tolerance mismatch, increase in number of interfacing surfaces, coolant leakage from interfaces around the machined area, the repair ring, the new cylinder liner, sealing elements, and so on. Hence, there is a need for an improved remanufacturing process for the damaged engine block.

U.S. Pat. No. 5,873,163 describes a method for repairing a cylinder block of an internal combustion engine. The cylinder block engages a cylinder head and includes an outer cylinder casting that surrounds an inner cylinder sleeve. The casting has corrosion formed in an end surface that faces the cylinder head. The method includes providing a repair ring that is separate and distinct from the cylinder sleeve and has a selected thickness. A counterbore is formed in the end surface of the cylinder casting to remove the corrosion therefrom. The counterbore has a depth that is no greater than the thickness of the ring. The ring is installed annularly about and in close tolerance fit with the cylinder sleeve and is introduced into the counterbore. At least one of the cylinder sleeve and the ring are machined to form thereon respective, generally co-planar surfaces that face the cylinder head.

### SUMMARY OF THE DISCLOSURE

In an aspect of the present disclosure, a method for remanufacturing an engine block is provided. The engine block includes a damaged area on an inner surface of a cylinder. The method includes removing a first liner from the cylinder. The first liner includes a first inner diameter defined by a first inner surface and a first outer diameter defined by a first outer surface. The method includes removing material from the damaged area on the inner surface of the cylinder. The method also includes providing a machined surface on the inner surface of the cylinder. The machined surface defines a machined diameter. The method further includes inserting a second liner into the cylinder. The second liner includes a second inner diameter defined by a second inner surface and a second outer diameter defined by a second outer surface. The second outer diameter is equal to the machined diameter.

In another aspect of the present disclosure, a remanufactured engine block is provided. The remanufactured engine block includes a cylinder having an inner surface. The remanufactured engine block also includes a machined surface provided on the inner surface of the cylinder. The machined surface defines a machined diameter. The remanufactured engine block further includes a liner provided within the cylinder. The liner includes an inner diameter defined by an inner surface and an outer diameter defined by an outer surface. The outer diameter is equal to the machined diameter.

In yet another aspect of the present disclosure, a method for remanufacturing an engine block is provided. The engine block includes a damaged area on an inner surface of a cylinder. The method includes removing a first liner from the cylinder. The first liner includes a first inner surface and a first outer surface. The method includes removing material from the damaged area on the inner surface of the cylinder. The method also includes providing a machined surface on the inner surface of the cylinder. The method further includes inserting a second liner into the cylinder. The second liner includes a second inner surface and a second outer surface. The second outer surface abuts the machined surface.

Other features and aspects of this disclosure will be apparent from the following description and the accompanying drawings.

### BRIEF DESCRIPTION OF THE DRAWINGS

FIG. 1 is a perspective view of an exemplary engine, according to an embodiment of the present disclosure;

FIG. 2 is a side cutaway view of a portion of the engine of FIG. 1 having a first liner, according to an embodiment of the present disclosure;

FIG. 3 is an enlarged view of a portion of FIG. 2, according to an embodiment of the present disclosure;

FIG. 4 is another view of the portion of the engine of FIG. 3 having a counterbore therein, according to an embodiment of the present disclosure;

FIG. 5 is another view of the portion of the engine of FIG. 4 with a second liner, according to an embodiment of the present disclosure;

FIG. 6 is another view of the portion of the engine of FIG. 4 with the second liner, according to another embodiment of the present disclosure;

FIG. 7 is a flowchart illustrating a method of remanufacturing the portion of the engine of FIG. 1, according to an embodiment of the present disclosure; and

FIG. 8 is a flowchart illustrating a method of remanufacturing the portion of the engine of FIG. 1, according to another embodiment of the present disclosure.

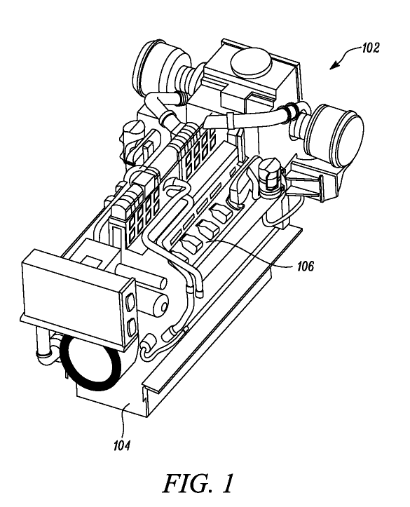

### DETAILED DESCRIPTION

Wherever possible, the same reference numbers will be used throughout the drawings to refer to the same or the like parts. Referring to FIG. 1, an exemplary engine 102 is illustrated. The engine 102 is an internal combustion engine powered by any fuel known in the art, such as natural gas, diesel, gasoline, and/or a combination thereof. In some embodiments, the engine 102 may be associated with a machine (not shown), such as a locomotive, a marine vessel, a land vehicle, and so on. The engine 102 and/or the machine may be employed in any industry including, but not limited to, construction, agriculture, forestry, mining, transportation, waste management, aviation, material handling, and power generation.

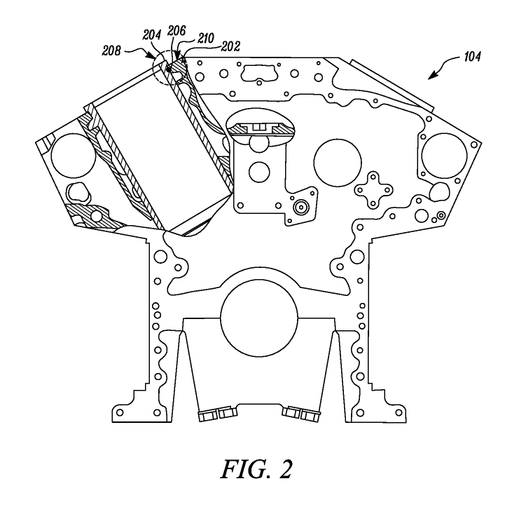

The engine 102 includes an engine block 104. The engine block 104 includes one or more cylinders 202 (shown in FIG. 2) provided therein. The cylinders 202 may be arranged in any configuration such as inline, radial, “V”, and so on. The engine 102 also includes a cylinder head 106 mounted on the engine block 104. The cylinder head 106 houses one or more components and/or systems (not shown) of the engine 102 such as a valve train, an intake manifold, an exhaust manifold, sensors, and so on. Additionally, the engine 102 may include various other components and/or systems (not shown) such as a crankcase, a fuel system, an air system, a cooling system, a lubrication system, a turbocharger, an exhaust gas recirculation system, an exhaust aftertreatment system, other peripheries, and so on.

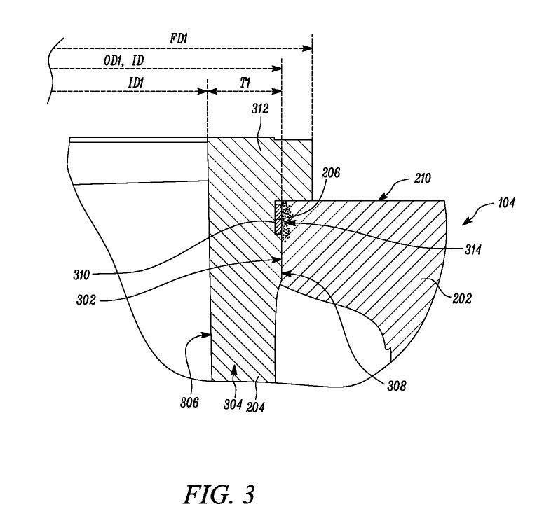

Referring to FIG. 2, a side cutaway view of the engine block 104 is illustrated. The engine block 104 includes the cylinder 202 provided therein. The engine block 104 also includes a first liner 204 provided within the cylinder 202. The engine block 104 also includes a first sealing material 206 provided between the first liner 204 and the cylinder 202. The cylinder 202, the first liner 204, and the first sealing material 206 will be explained in more detail with reference to FIG. 3.

Referring to FIG. 3, an enlarged view of a circled portion 208 (shown in FIG. 2) of the engine block 104 is illustrated. The cylinder 202 includes an inner surface 302. The inner surface 302 defines an inner diameter “ID” of the cylinder 202. The first liner 204 defines a first body 304. The first body 304 includes a first inner surface 306. The first inner surface 306 defines a first inner diameter “ID1” of the first liner 204. The first body 304 also includes a first outer surface 308.

The first outer surface 308 is disposed opposing the first inner surface 306. The first outer surface 308 defines a first outer diameter “OD1” of the first liner 204. Accordingly, the first body 304 defines a first thickness “T1” of the first liner 204 between the first inner surface 306 and the first outer surface 308. Also, the first outer diameter “OD1” is equal to the inner diameter “ID”. Accordingly, the first liner 204 is removably affixed within the cylinder 202 using a friction fit between the first outer surface 308 and the inner surface 302. In other embodiments, the first liner 204 may be removably affixed within the cylinder 202 using any other fit based on a dimensional tolerance therebetween, such as a clearance fit between the first outer surface 308 and the inner surface 302.

Further, the first sealing material 206 is provided between the first outer diameter “OD1” and the inner diameter “ID”. More specifically, in the illustrated embodiment, the first sealing material 206 is provided in a first groove 310 provided in the first outer surface 308. In other embodiments, the first groove 310 may be provided in the inner surface 302 of the cylinder 202 based on application requirements. The first sealing material 206 may be manufactured from any sealing material known in the art, such as a metal, a polymer, a combination thereof, and so on.

The first liner 204 also includes a first flange 312. The first flange 312 defines a first flange diameter “FD1”. The first flange diameter “FD1” is greater than the first outer diameter “OD1” and the inner diameter “ID”. The first flange 312 is adapted to removably affix the first liner 204 within the cylinder 202. More specifically, during assembly of the engine 102, the cylinder head 106 may be removably affixed over the engine block 104 in a manner such that the first flange 312 may be sandwiched between a top surface 210 (shown in FIG. 2) of the cylinder 202 and a bottom surface (not shown) of the cylinder head 106. Additionally, one or more sealing elements, gaskets, and so on may also be provided between the first flange 312 and the top surface 210 of the cylinder 202, and/or between the first flange 312 and the bottom surface of the cylinder 202 based on application requirements.

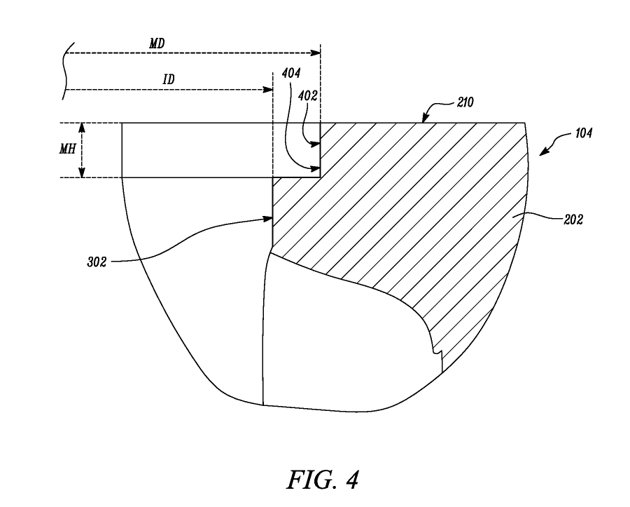

During operation of the engine 102, an engine coolant (not shown) circulated through lubrication passages (not shown) within the engine block 104 may collect in and/or around the first groove 310 between the first outer surface 308 and the inner surface 302. Also, in a situation of a failure of the first sealing material 206, the engine coolant may flow pass the first sealing material 206, in turn, allowing collection of the engine coolant in and/or around the first groove 310. As a result, the collected engine coolant may result in formation of a damaged area 314 on the inner surface 302. The damaged area 314 may be in the form of wear, corrosion, erosion, cavitation, and so on, on the inner surface 302 of the cylinder 202. In such a situation, the engine block 104 may be remanufactured in order to reuse the engine block 104 and will be explained in more detail with reference to FIGS. 4 to 6.

Referring to FIG. 4, the first liner 204 is removed from the cylinder 202. Also, the first sealing material 206 is removed from the cylinder 202. Further, the damaged area 314 on the inner surface 302 of the cylinder 202 is removed. More specifically, material is removed from the inner surface 302 of the cylinder 202 in order to remove the damaged area 314. Accordingly, a counterbore or a machined surface 402 is provided on the inner surface 302 of the cylinder 202. In the illustrated embodiment, the machined surface 402 is provided along the top surface 210 of the cylinder 202 based on a location of the damaged area 314. In other embodiments, the machined surface 402 may be provided on any other portion of the inner surface 302 of the cylinder 202 based on the location of the damaged area 314.

The machined surface 402 defines a machined diameter “MD” and a machined height “MH”. The machined diameter “MD” is greater than the inner diameter “ID” defined by the inner surface 302 of the cylinder 202. The machined surface 402 also includes a wear coating 404, such as a cavitation coating, a corrosion coating, and/or an erosion coating provided thereon. Optionally, the wear coating 404 may extend along the inner surface 302 of the cylinder 202. The cavitation coating, the corrosion coating, and/or the erosion coating may be any cavitation resistant protection, corrosion resistant protection, and/or erosion resistant protection respectively, known in the art.

In the illustrated embodiment, the machined surface 402 includes a stepped configuration. In other embodiments, the machined surface 402 may include any other configuration, such as a beveled configuration, a chamfered configuration, a filleted configuration, and so on based on application requirements. The machined surface 402 may be formed using any machining process known in the art, such as milling, reaming, grinding, polishing, and so on.

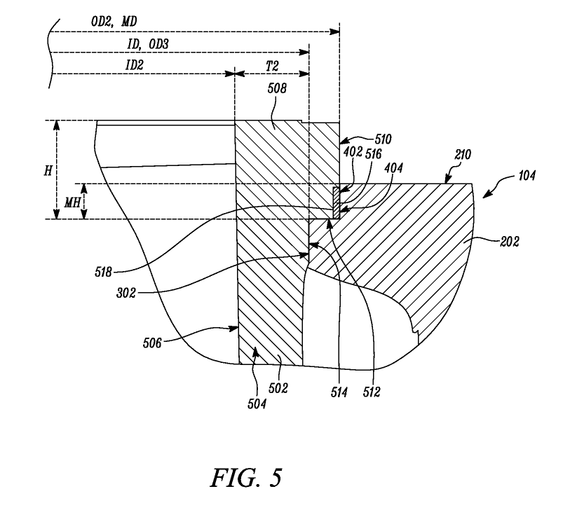

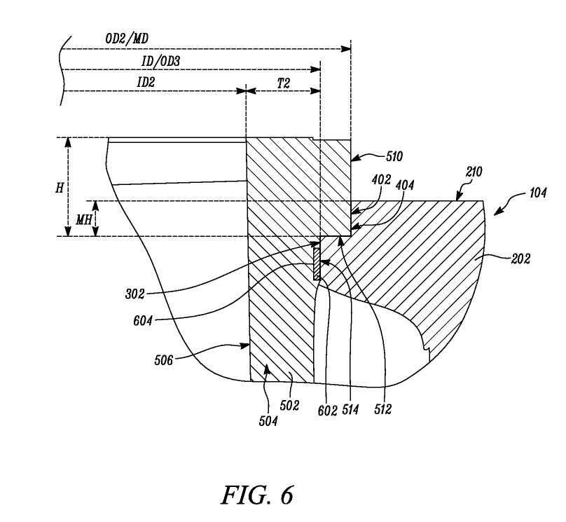

Referring to FIGS. 5 and 6, a second liner 502 is provided within the cylinder 202. The second liner 502 defines a second body 504. The second body 504 includes a second inner surface 506. The second inner surface 506 defines a second inner diameter “ID2” of the second liner 502. The second inner diameter “ID2” is equal to the first inner diameter “ID1” of the first liner 204. The second liner 502 also includes a second flange 508. The second flange 508 includes a second outer surface 510.

The second outer surface 510 defines a second flange diameter or a second outer diameter “OD2” of the second liner 502. The second outer diameter “OD2” is greater than the first outer diameter “OD1” of the first liner 204 and the inner diameter “ID” of the cylinder 202. The second flange 508 is adapted to removably affix the second liner 502 within the cylinder 202. More specifically, during assembly of the engine 102, the cylinder head 106 may be removably affixed over the engine block 104 in a manner such that the second flange 508 may be sandwiched between a machined bottom surface 512 of the cylinder 202 and the bottom surface (not shown) of the cylinder head 106. Additionally, one or more sealing elements, gaskets, and so on may also be provided between the second flange 508 and the machined bottom surface 512 of the cylinder 202, and/or between the second flange 508 and the bottom surface of the cylinder head 106.

The second body 504 also includes a third outer surface 514. The third outer surface 514 is disposed opposing the second inner surface 506. The third outer surface 514 defines a third outer diameter “OD3” of the second liner 502. The third outer diameter “OD3” is equal to the first outer diameter “OD1” of the first liner 204. Accordingly, the second body 504 defines a second thickness “T2” of the second liner 502 between the second inner surface 506 and the third outer surface 514. The second thickness “T2” is equal to the first thickness “T1” of the first liner 204.

Also, the third outer diameter “OD3” is equal to the inner diameter “ID” of the cylinder 202. Accordingly, the second liner 502 is removably affixed within the cylinder 202 using a friction fit between the third outer surface 514 and the inner surface 302 of the cylinder 202. In other embodiments, the second liner 502 may be removably affixed within the cylinder 202 using any other fit based on a dimensional tolerance therebetween, such as a clearance fit between the third outer surface 514 and the inner surface 302 of the cylinder 202. Further, the second outer diameter “OD2” is equal to the machined diameter “MD”. As such, in the assembled position of the second liner 502 within the cylinder 202, the second outer surface 510 abuts the machined surface 402. The second liner 502 also includes a height “H” defined by the second flange 508. In the illustrated embodiment, the height “H” is greater than the machined height “MH” of the machined surface 402. In other embodiments, the height “H” may be equal to the machined height “MH” based on application requirements.

Referring to FIG. 5, a second sealing material 516 is provided between the second outer diameter “OD2” and the machined diameter “MD”. More specifically, in the illustrated embodiment, the second sealing material 516 is provided in a second groove 518 provided in the second outer surface 510. In other embodiments, the second groove 518 may be, additionally or alternatively, provided in the machined surface 402 based on application requirements.

Alternatively, as shown in FIG. 6, the second sealing material 602 is provided between the third outer diameter “OD3” and the inner diameter “ID” of the cylinder 202. More specifically, in the illustrated embodiment, the second sealing material 602 is provided in a second groove 604 provided in the third outer surface 514. In other embodiments, the second groove 604 may be, additionally or alternatively, provided in the inner surface 302 of the cylinder 202 based on application requirements. In such a situation, the second groove 518 provided in the second outer surface 510 and/or the machined surface 402 may be omitted.

In some embodiments, both the second grooves 518, 604 may be provided in the second outer surface 510 and/or the machined surface 402, and the third outer surface 514 and/or the inner surface 302, with the second sealing material 516, 602 therein respectively. The second sealing material 516, 602 may be manufactured from any sealing material known in the art, such as a metal, a polymer, a combination thereof, and so on.

### INDUSTRIAL APPLICABILITY

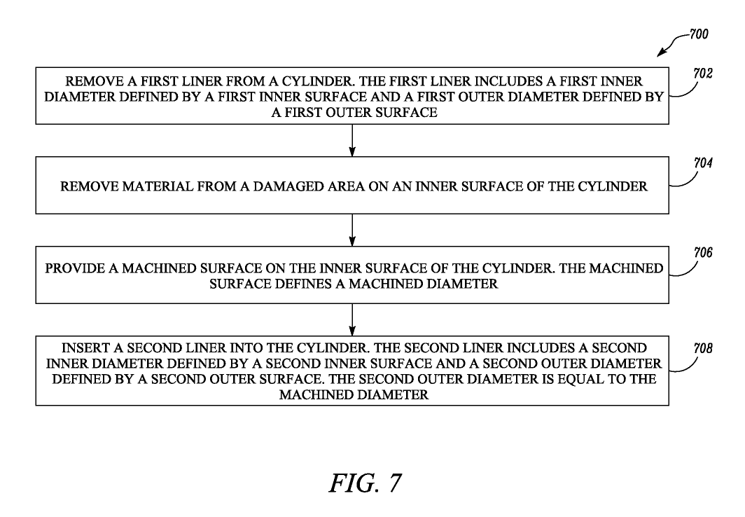

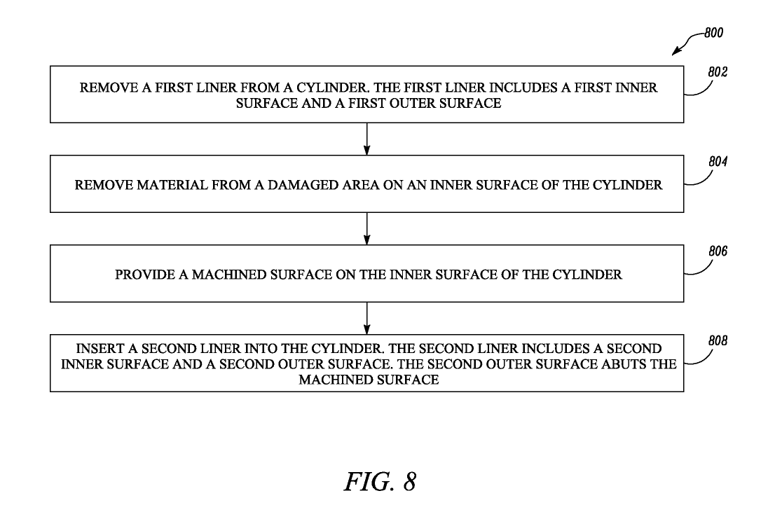

The present disclosure relates to a method 700, 800 for remanufacturing the engine block 104. Referring to FIGS. 7 and 8, a flowchart for the method 700, 800 respectively is illustrated. The engine 102 includes the damaged area 314 on the inner surface 302 of the cylinder 202, as shown in FIG. 3. At step 702, 802, as shown in FIG. 4, the first liner 204 is removed from the cylinder 202. The first liner 204 may be removed from the cylinder 202 by dissembling the cylinder head 106 with respect to the engine 102, disassembling one or more fastening elements (not shown) associated with the engine block 104, the cylinder head 106, and/or the first liner 204, disassembling the one or more sealing elements, such as the first sealing material 206, gaskets, and so on. The first liner 204 includes the first inner diameter “ID1” defined by the first inner surface 306 and the first outer diameter “OD1” defined by the first outer surface 308.

At step 704, 804, as shown in FIG. 4, the material is removed from the damaged area 314 on the inner surface 302 of the cylinder 202. More specifically, the damaged area 314 may be removed by machining the inner surface 302 using any known machining process, such as milling, reaming, grinding, polishing, and so on. At step 706, 806, the counterbore or the machined surface 402 is provided on the inner surface 302 of the cylinder 202. The machined surface 402 defines the machined diameter “MD” and the machined height “MH”. Additionally, the wear coating 404, such as the cavitation coating, the corrosion coating, and/or the erosion coating, is placed on the machined surface 402 and/or the machined bottom surface 512.

At step, 708, 808, as shown in FIGS. 5 and 6, the second liner 502 is inserted into the cylinder 202. The second liner 502 includes the second inner diameter “ID2” defined by the second inner surface 506. The second liner 502 also includes the second outer diameter “OD2” defined by the second outer surface 510. The second outer diameter “OD2” is equal to the machined diameter “MD”. Accordingly, the second outer surface 510 abuts the machined surface 402 of the cylinder 202.

Also, the second liner 502 includes the third outer diameter “OD3” defined by the third outer surface 514. The third outer diameter “OD3” is equal to the inner diameter “ID” of the cylinder 202. Accordingly, the second liner 502 is removably affixed within the cylinder 202 using the friction fit between the third outer surface 514 and the inner surface 302 of the cylinder 202. In other embodiments, the second liner 502 may be removably affixed within the cylinder 202 using any other fit based on the dimensional tolerance therebetween, such as the clearance fit between the third outer surface 514 and the inner surface 302 of the cylinder 202.

Further, as shown in FIG. 5, the second sealing material 516 is inserted between the second outer diameter “OD2” and the machined diameter “MD”. More specifically, the second sealing material 516 is provided in the second groove 518 of the second outer surface 510 of the second liner 502 and/or the machined surface 402 of the cylinder 202. Alternatively, as shown in FIG. 6, the second sealing material 602 is inserted between the third outer diameter “OD3” and the inner diameter “ID” of the cylinder 202. More specifically, the second sealing material 602 is provided in the second groove 604 of the third outer surface 514 of the second liner 502 and/or the inner surface 302 of the cylinder 202.

The method 700, 800 provides a simple, effective, and cost-efficient method for remanufacturing of the engine block 104. The method 700, 800 provides the second liner 502 with the second flange 508 having an oversized dimension with respect to the first flange 312 of the first liner 204. As such, the second flange 508 fills the counterbore or the machined surface 402 without use of an additional repair ring in the machined surface 402. As a result, cost of remanufacturing the engine block 104 may be reduced. The method 700, 800 of remanufacturing of the engine block 104 may be retrofittable and serviceable in field for any type of the engine block 104.

The second liner 502 may be manufactured with minimal changes to a casting pattern used for manufacture of the first liner 204. The second sealing material 516, 602 may be manufactured with minimal changes to dimensions of the first sealing material 206. Also, the machined surface 402 may be formed on the inner surface 302 of the cylinder 202 with minimal or no changes to a current machining program. As such, the method 700, 800 may improve cost effectiveness of the remanufacturing process. Additionally, the cavitation coating, the corrosion coating, and/or the erosion coating provided on the machined surface 402 and/or the machined bottom surface 512 may provide protection against further damage to the machined surface 402 of the cylinder 202.

While aspects of the present disclosure have been particularly shown, and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A method for remanufacturing an engine block, the engine block having a damaged area on an inner surface of a cylinder, the method comprising:
removing a first liner from the cylinder, the first liner having a first inner diameter defined by a first inner surface and a first outer diameter defined by a first outer surface;
removing material from the damaged area on the inner surface of the cylinder;
providing a machined surface on the inner surface of the cylinder, the machined surface defining a machined diameter; and
inserting a second liner into the cylinder, the second liner having a second inner diameter defined by a second inner surface and a second outer diameter defined by a second outer surface, wherein the second outer diameter is equal to the machined diameter.

2. The method of claim 1, wherein the second inner diameter is equal to the first inner diameter.

3. The method of claim 1, wherein the second outer diameter is greater than the first outer diameter.

4. The method of claim 1, wherein the first liner defines a first body having a first thickness and the second liner defines a second body having a second thickness, wherein the first thickness is equal to the second thickness.

5. The method of claim 1, wherein the second outer diameter is defined on a flange of the second liner.

6. The method of claim 5, wherein a height of the flange is at least equal to a height of the machined surface.

7. The method of claim 1 further comprising inserting a sealing material between the second outer diameter and the machined diameter.

8. The method of claim 1, wherein the second liner further includes a third outer diameter defined by a third outer surface, the third outer surface being sized to allow any one of a friction fit and a clearance fit between the third outer surface and the inner surface of the cylinder.

9. The method of claim 8 further comprising inserting a sealing material between the third outer diameter and the inner surface of the cylinder.

10. The method of claim 1 further comprising placing at least one of a cavitation coating, a corrosion coating, and an erosion coating on the machined surface.

11. The method of claim 1, wherein the machined surface is provided along a top surface of the cylinder.

12. A remanufactured engine block comprising:
a cylinder having an inner surface;
a machined surface provided on the inner surface of the cylinder, the machined surface defining a machined diameter; and
a liner provided within the cylinder, the liner having an inner diameter defined by an inner surface and an outer diameter defined by an outer surface, wherein the outer diameter is equal to the machined diameter.

13. The remanufactured engine block of claim 12, wherein the machined diameter is greater than an inner diameter defined by the inner surface of the cylinder.

14. The remanufactured engine block of claim 12, wherein the outer diameter is defined on a flange of the liner.

15. The remanufactured engine block of claim 14, wherein a height of the flange is at least equal to a height of the machined surface.

16. The remanufactured engine block of claim 12 further comprising a sealing material provided between the outer diameter and the machined diameter.

17. The remanufactured engine block of claim 12 further comprising at least one of a cavitation coating, a corrosion coating, and an erosion coating provided on the machined surface.

18. The remanufactured engine block of claim 12, wherein the machined surface is provided along a top surface of the cylinder.

19. The remanufactured engine block of claim 12, wherein the machined surface includes a stepped configuration.

20. A method for remanufacturing an engine block, the engine block having a damaged area on an inner surface of a cylinder, the method comprising:
removing a first liner from the cylinder, the first liner having a first inner surface and a first outer surface;
removing material from the damaged area on the inner surface of the cylinder;
providing a machined surface on the inner surface of the cylinder; and
inserting a second liner into the cylinder, the second liner having a second inner surface and a second outer surface, wherein the second outer surface abuts the machined surface.
